(19) United States
(12) Patent Application Publication
(10) Pub. No.: US 2024/0153689 A1
(43) Pub. Date: May 9, 2024

(54) FRAUNHOFER RESONANT COIL COUPLED WITH ELECTROMAGNETIC FIELD

(71) Applicant: Electronics and Telecommunications Research Institute, Daejeon (KR)

(72) Inventors: Je Hoon YUN, Daejeon (KR); Gwangzeen KO, Daejeon (KR); Seong-Min KIM, Daejeon (KR); Jung Ick MOON, Daejeon (KR); Seung Keun PARK, Daejeon (KR); Dong-won JANG, Daejeon (KR); In Kui CHO, Daejeon (KR)

(73) Assignee: Electronics and Telecommunications Research Institute, Daejeon (KR)

(21) Appl. No.: 18/500,820

(22) Filed: Nov. 2, 2023

(30) Foreign Application Priority Data
Nov. 3, 2022 (KR) 10-2022-0145494
Jun. 21, 2023 (KR) 10-2023-0079919

(51) Int. Cl. H01F 5/04; H01F 27/28; H01F 38/14

(52) U.S. Cl. CPC H01F 5/04; H01F 27/2852; H01F 38/14; H01F 2005/006

(57) ABSTRACT

A resonant coil coupled with an electromagnetic field is disclosed. A Fraunhofer resonant coil includes an upper spiral element and a lower spiral element, an upper conical element connected to the upper spiral element and including one or more layers formed of a plurality of plies, a lower conical element connected to the lower spiral element and including one or more layers formed of a plurality of plies, and a feeding device connected to a gap between the upper conical element and the lower conical element and configured to supply power.

### CROSS-REFERENCE TO RELATED APPLICATION

This application claims the benefit of Korean Patent Application No. 10-2022-0145494, filed on Nov. 3, 2022, and Korean Patent Application No. 10-2023-0079919, filed on Jun. 21, 2023, in the Korean Intellectual Property Office, the entire disclosures of which are incorporated herein by reference for all purposes.

### BACKGROUND

### 1. Field of the Invention

One or more embodiments relate to a Fraunhofer resonant coil coupled with an electromagnetic field.

### 2. Description of the Related Art

A resonant coil coupled with an electromagnetic field has higher power transmission efficiency and may transmit power over a longer distance compared to wireless power transmission technology of a resonant coil coupled with a magnetic field and a resonant coil coupled with an electric filed.

Power may be transmitted by generating an electric field adjacent to a resonant coil using a high charge distribution at both end portions of the resonant coil and a magnetic field adjacent to the resonant coil by a large current generated at the center of the resonant coil.

### SUMMARY

Embodiments provide, in a resonant coil coupled with an electromagnetic field, considering a distribution of charge and current of a resonant coil, a resonant coil in which a coil segment having a high potential difference is positioned close to a central axis of the resonant coil and a resonant coil having a high current is at the outermost portion of the resonant coil so that a large opening surface is secured.

Embodiments provide a Fraunhofer resonant coil coupled with an electromagnetic field that transmits long-distance power and has high power transmission efficiency, using a resonant coil having a structure that additionally generates an electric field and a magnetic field that enhance electrical coupling and magnetic coupling, in a resonant coil coupled with an electromagnetic field.

Embodiments provide a Fraunhofer resonant coil coupled with an electromagnetic field in which an impedance decreases as the transmission distance increases and a frequency is tuned with the narrowband due to a high Q.

According to an aspect, there is provided a Fraunhofer resonant coil including an upper spiral element and a lower spiral element, an upper conical element connected to the upper spiral element and including one or more layers formed of a plurality of plies, a lower conical element connected to the lower spiral element and including one or more layers formed of a plurality of plies, and a feeding device connected to a gap between the upper conical element and the lower conical element and configured to supply power.

The upper spiral element and the lower spiral element may be formed to be wound around a center of a resonant coil.

The upper conical element and the lower conical element may be formed such that a layer connected to the feeding device is wound around a center of a resonant coil.

The one or more layers of the upper conical element and the lower conical element may be an odd number of layers.

The upper conical element and the lower conical element may be formed such that the one or more layers are formed in a circular shape.

The upper spiral element and the lower spiral element may be formed in one of an elliptical shape, a rectangular shape, a hexagonal shape, and an octagonal shape.

The upper conical element and the lower conical element may be formed such that a plurality of plies of a layer connected to the feeding device is formed in one of an elliptical shape, a rectangular shape, a hexagonal shape, and an octagonal shape.

The gap may be formed greater than a space between a plurality of layers of the upper conical element and a plurality of layers of the lower conical element.

A size of the gap may be determined based on a resonant frequency of the Fraunhofer resonant coil.

The Fraunhofer resonant coil may further include a reactance (LC) element to adjust a resonant frequency of the Fraunhofer resonant coil.

The upper spiral element and the lower spiral element may be formed using a linear element and a rectangular element capable of assembling and the upper conical element and the lower conical element may be formed using the linear element, the rectangular element, and a connection element connecting the one or more layers and capable of assembling.

The upper spiral element and the lower spiral element may be formed such that a point where a current is maximum is at an outermost portion of the Fraunhofer resonant coil and a point where a charge is maximum is at a center of the Fraunhofer resonant coil.

According to another aspect, there is provided a Fraunhofer resonant coil including an upper spiral element and a lower spiral element, an upper conical element connected to the upper spiral element and including a plurality of plies and one or more layers, a lower conical element connected to the lower spiral element and the upper conical element and including a plurality of plies and one or more layers, and a feeding loop configured to supply power to at least one of the upper spiral element, the lower spiral element, the upper conical element, and the lower conical element by generating a magnetic field.

The feeding loop may be positioned on one side of the upper spiral element or one side of the lower spiral element.

The feeding loop may be at a gap between the upper conical element and the lower conical element.

The upper spiral element and the lower spiral element may be formed to be wound around a center of a resonant coil.

The upper conical element and the lower conical element may be formed such that a layer connected to the feeding device is wound around a center of a resonant coil.

According to still another aspect, there is provided a Fraunhofer resonant coil including an upper spiral element and a lower spiral element, an upper conical element connected to the upper spiral element and including a plurality of plies and one or more layers, a lower conical element connected to the lower spiral element and the upper conical element and including a plurality of plies and one or more layers, and a feeding dipole configured to supply power to at least one of the upper spiral element, the lower spiral element, the upper conical element, and the lower conical element by generating an electric field.

The upper spiral element and the lower spiral element may be formed to be wound around a center of a resonant coil.

The upper conical element and the lower conical element may be formed such that a layer connected to the feeding device is wound around a center of a resonant coil.

Additional aspects of embodiments will be set forth in part in the description which follows and, in part, will be apparent from the description, or may be learned by practice of the disclosure.

According to embodiments, a maximum magnetic field opening surface may be secured by forming a resonant coil so that a point with a high current is at the outermost portion of the resonant coil in an upper spiral element and a lower spiral element and/or an upper conical element and a lower conical element of a Fraunhofer resonant coil, and a maximum electric field may be formed at the center of the resonant coil by positioning a point with a high charge at the center of the resonant coil.

According to embodiments, when the number of plies and the number of layers of an upper conical element and a lower conical element of a Fraunhofer resonant coil increase, according to the effect of increasing a layer space and a ply space, the charge concentration phenomenon may be improved and the line resistance may be reduced to reduce heat loss.

According to embodiments, power may be transmitted over a long distance due to a structural characteristic of a Fraunhofer resonant coil and high power transmission efficiency may be obtained at the same transmission distance. In addition, it is possible to improve the problem that the narrow frequency tuning becomes difficult because the impedance decreases and Q increases as the transmission distance increases.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a resonant coil coupled with an electromagnetic field;

FIG. 2 is a cross-sectional view illustrating the resonant coil coupled with an electromagnetic field of FIG. 1;

FIG. 3 is a diagram illustrating a Fraunhofer resonant coil coupled with an electromagnetic field, according to various embodiments;

FIG. 4 is a cross-sectional view illustrating the Fraunhofer resonant coil coupled with an electromagnetic field of FIG. 3, according to various embodiments;

FIG. 5 is a diagram illustrating an upper spiral element and a lower spiral element of the Fraunhofer resonant coil coupled with an electromagnetic field, according to various embodiments;

FIG. 6 is a diagram illustrating an upper conical element and a lower conical element of the Fraunhofer resonant coil coupled with an electromagnetic field, according to various embodiments;

FIG. 7 is a diagram illustrating the feeding device and a layer of the upper conical element and a layer of the lower conical element connected to the feeding device of the Fraunhofer resonant coil coupled with an electromagnetic field, according to various embodiments;

FIG. 8 is a diagram schematically illustrating current and charge distributions of the Fraunhofer resonant coil coupled with an electromagnetic field, according to various embodiments;

FIG. 9 is a diagram illustrating an operation of transmitting and receiving power using the Fraunhofer resonant coil coupled with an electromagnetic field, according to various embodiments;

FIG. 10 is a diagram illustrating an impedance matching 2Ω smart chart of the Fraunhofer resonant coil coupled with an electromagnetic field, according to various embodiments;

FIG. 11 is a diagram illustrating an S parameter of the Fraunhofer resonant coil coupled with an electromagnetic field, according to various embodiments;

FIG. 12 is a diagram illustrating heat loss and radiation loss of the Fraunhofer resonant coil coupled with an electromagnetic field, according to various embodiments;

FIG. 13 is a diagram illustrating the power transmission efficiency of the Fraunhofer resonant coil coupled with an electromagnetic field, according to various embodiments;

FIGS. 14 and 15 are diagrams illustrating a Fraunhofer resonant coil coupled with an electromagnetic field including a feeding loop, according to various embodiments;

FIG. 16 is a diagram illustrating an impedance matching 2Ω smart chart of the Fraunhofer resonant coil coupled with an electromagnetic field, according to various embodiments;

FIG. 17 is a diagram illustrating an S parameter of the Fraunhofer resonant coil coupled with an electromagnetic field, according to various embodiments;

FIG. 18 is a diagram illustrating heat loss and radiation loss of the Fraunhofer resonant coil coupled with an electromagnetic field, according to various embodiments;

FIGS. 19 and 20 are diagrams illustrating a circular Fraunhofer resonant coil coupled with an electromagnetic field, according to various embodiments;

FIG. 21 is a diagram illustrating a shape of an upper spiral element and a lower spiral element of a Fraunhofer resonant coil coupled with an electromagnetic field, according to various embodiments;

FIG. 22 is a diagram illustrating a shape of an upper conical element and a lower conical element of a Fraunhofer resonant coil coupled with an electromagnetic field, according to various embodiments;

FIG. 23 is a diagram illustrating a Fraunhofer resonant coil coupled with an electromagnetic field including a feeding dipole, according to various embodiments;

FIG. 24 is a diagram illustrating assembly components of a Fraunhofer resonant coil coupled with an electromagnetic field, according to various embodiments;

FIG. 25 is a diagram illustrating a Fraunhofer resonant coil coupled with an electromagnetic field including a fixed reactance (LC) element, according to various embodiments;

FIG. 26 is a diagram illustrating a Fraunhofer resonant coil coupled with an electromagnetic field including a variable LC element, according to various embodiments; and

FIG. 27 is a diagram illustrating the power transmission efficiency measured in a Fraunhofer region when the Fraunhofer resonant coil of FIG. 15 is designed as a perfect conductor, according to various embodiments.

### DETAILED DESCRIPTION

Hereinafter, embodiments will be described in detail with reference to the accompanying drawings. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

The terminology used herein is for the purpose of describing particular embodiments only and is not intended to be limiting. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

Unless otherwise defined, all terms including technical and scientific terms used herein have the same meaning as commonly understood by one of ordinary skill in the art to which the embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

When describing the embodiments with reference to the accompanying drawings, like reference numerals refer to like components and a repeated description related thereto will be omitted. In the description of embodiments, detailed description of well-known related structures or functions will be omitted when it is deemed that such description will cause ambiguous interpretation of the present disclosure.

Wireless power transmission technology using an electromagnetic field may be divided into an induction method and a resonant method. The induction method may transmit power through inductive coupling of an electric field and a magnetic field existing adjacent to an induction coil. The induction method has a short transmission distance but is used for high power transmission.

The resonant method may be divided into technology using an electromagnetic field existing in the far field radiated from an antenna into a space and technology using an electric field and a magnetic field existing in the near field of a resonant coil.

In the resonant method, a resonant coil method may be used for mid-range transmission, which is a near field, by lowering the amount of spatial radiation. The resonant coil method may be divided into a magnetic coupling method, an electrical coupling method, and an electromagnetic coupling method.

The electromagnetic coupling method causes an electric field and a magnetic field adjacent to a nonradiative electromagnetic resonant coil to be positively coupled, that is, to be coupled with each other in a direction of increasing the total amount of coupling, so that power may be transmitted over a longer distance having high power transmission efficiency.

The electromagnetic coupling method has an advantage of being easy to manufacture when a resonant coil is manufactured with a wire. For example, a resonant coil according to the electromagnetic coupling method may be manufactured with a wire made of a metal such as copper or silver.

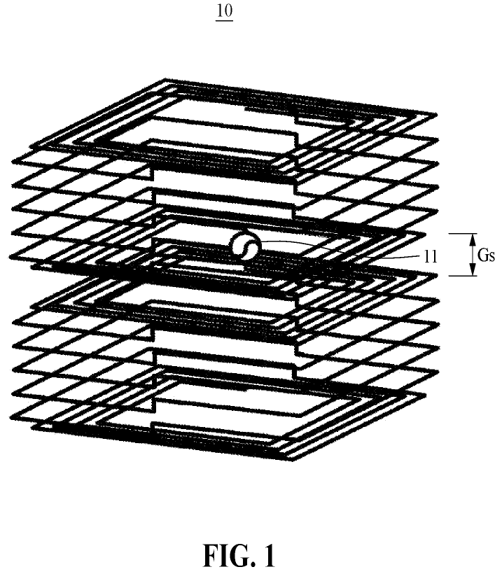

FIG. 1 is a diagram illustrating a resonant coil 10 coupled with an electromagnetic field.

Referring to FIG. 1, the resonant coil 10 coupled with an electromagnetic field may include a feeding device 11. The resonant coil 10 may induce a positive coupling between an electric field and a magnetic field generated adjacent to the resonant coil 10, increase the total degree of coupling, and transmit power over a long distance with high efficiency.

The resonant coil 10 of FIG. 1 may generate a magnetic field that increases the degree of coupling according to the current distributed at both ends of the resonant coil 10, and the charge distribution existing at the center of the resonant coil 10 may additionally generate an electric field that increases the degree of coupling according to a gap Gs at the center of the resonant coil 10.

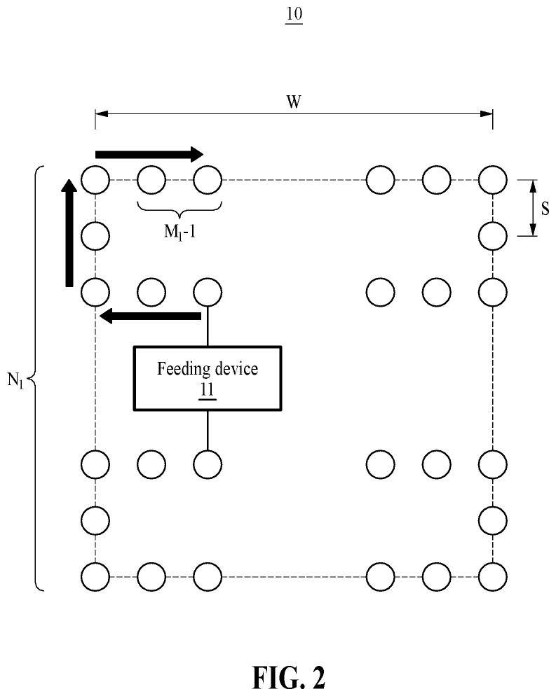

FIG. 2 is a cross-sectional view illustrating the resonant coil 10 coupled with an electromagnetic field of FIG. 1.

As shown in FIG. 2, the resonant coil 10 may include the feeding device 11. FIG. 2 is a diagram illustrating the resonant coil 10 including total 10 layers and 4 plies (i.e., N₁=10 and N₂=4) of an upper layer and a lower layer, respectively. N₂ may represent the number of layers of each upper and lower layer.

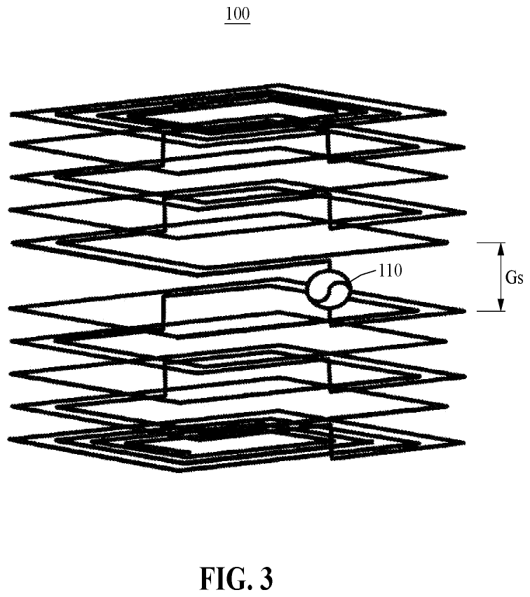

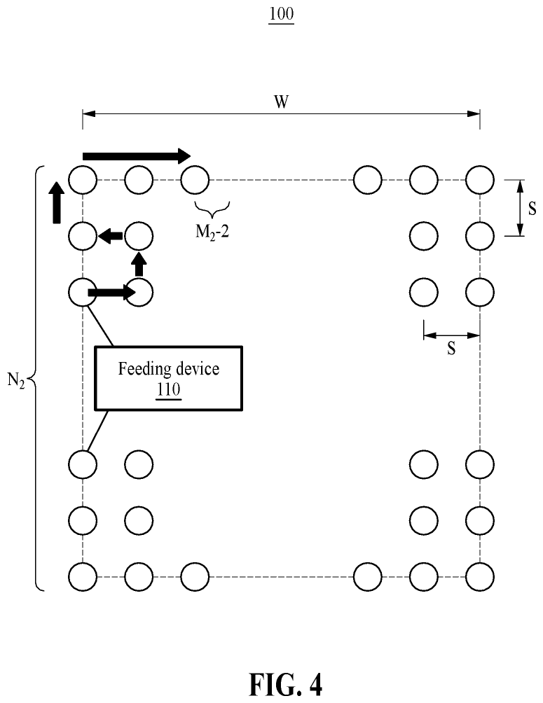

FIG. 3 is a diagram illustrating a Fraunhofer resonant coil 100 coupled with an electromagnetic field, according to various embodiments. FIG. 4 is a cross-sectional view illustrating the Fraunhofer resonant coil 100 coupled with an electromagnetic field of FIG. 3, according to various embodiments.

FIGS. 3 and 4 are examples of the Fraunhofer resonant coil 100 coupled with an electromagnetic field and FIG. 3 illustrates a structure of the Fraunhofer resonant coil 100 including 10 layers and 4 plies (i.e., N₂=10 and M₂=4).

Referring to FIG. 3, according to an embodiment, the Fraunhofer resonant coil 100 may include an upper spiral element, a lower spiral element, an upper conical element connected to the upper spiral element and including one or more layers formed of a plurality of plies, a lower conical element connected to the lower spiral element and including one or more layers formed of a plurality of plies, and a feeding device 110 connected to a gap between the upper conical element and the lower conical element and configured to supply power the Fraunhofer resonant coil 100

The Fraunhofer resonant coil 100 shown in FIG. 3 may improve that a large opening surface is not secured and an electric field and a magnetic field that increase the degree of coupling are not secured because points having a high potential difference are at the outer portion of the Fraunhofer resonant coil 100 and points having a high current are positioned inside the Fraunhofer resonant coil 100.

In addition, the Fraunhofer resonant coil 100 shown in FIG. 3 may improve heat loss caused by a charge concentration phenomenon due to a narrow space between a layer and a ply.

The power transmission efficiency may be improved in long-distance transmission when the Fraunhofer resonant coil 100 shown in FIG. 3 is used. As the transmission distance increases with respect to the Fraunhofer resonant coil 100, the input/output impedance decreases and the impedance matching and frequency tuning according to the frequency narrowband due to a high Q may be easily performed.

As shown in FIG. 3, the Fraunhofer resonant coil 100 may be formed such that the feeding device 110 is at the outermost portion of the Fraunhofer resonant coil 100, and starting from the feeding device 110, the upper spiral element and the lower spiral element have a spiral shape twisted inwardly. The upper conical element and the lower conical element may be formed of one or more layers so that the upper spiral element and the lower spiral element have a spiral shape twisted inwardly. In addition, each of the one or more layers of the upper conical element and the lower conical element may be formed of a plurality of plies.

Referring to FIG. 3, the central area of the Fraunhofer resonant coil 100 and a point having a high current in the upper spiral element and the lower spiral element may be at the outermost portion of the Fraunhofer resonant coil 100 so that the maximum magnetic field opening surface is secured.

In addition, the central area of the Fraunhofer resonant coil 100 and a point having a high amount of charge in the upper spiral element and the lower spiral element may be at the center of the Fraunhofer resonant coil 100 so that an electric field that increases the degree of coupling is formed at the center of the Fraunhofer resonant coil 100.

For example, the central area of the Fraunhofer resonant coil 100 may include a gap where the feeding device 110 is positioned and a layer connected to the feeding device 110 among one or more layers of the upper conical element and the lower conical element.

For example, one or more layers of the upper conical element and the lower conical element may be formed of an odd number of layers. When one or more layers of the upper conical element and the lower conical element are an odd number of layers, it is easy to connect segments of the Fraunhofer resonant coil 100 so that the Fraunhofer resonant coil 100 is easily manufactured.

Referring to FIG. 3, the Fraunhofer resonant coil 100 may include the upper conical element and the lower conical element formed of a plurality of plies and one or more layers. When a layer space and a ply space (e.g., S of FIG. 4) are greatly narrower than the width (e.g., W of FIG. 4) of the Fraunhofer resonant coil 100, the number of plies of the upper conical element and the lower conical element increases and the number of layers increases so that the effect of widening the layer space and the ply space is obtained. When the layer space and ply space widen, the charge drift phenomenon may be improved and the line resistance may be reduced to reduce heat loss.

The gap (e.g., Gs of FIG. 3) of the Fraunhofer resonant coil 100 may be formed greater than the interlayer space (e.g., S of FIG. 4) of the upper conical element and lower conical element.

The far field region may be collectively referred to as a Fraunhofer region (e.g., transmission distance D>λ/2π=0.159λ). According to various embodiments, the Fraunhofer resonant coil 100 may have a power transmission efficiency greater than or equal to 50% in the Fraunhofer region and may transmit power over a longer transmission distance than the Fraunhofer region.

That is, according to various embodiments, the Fraunhofer resonant coil 100 may transmit power with a power transmission efficiency greater than or equal to 50% even when the transmission di stance is the Fraunhofer region.

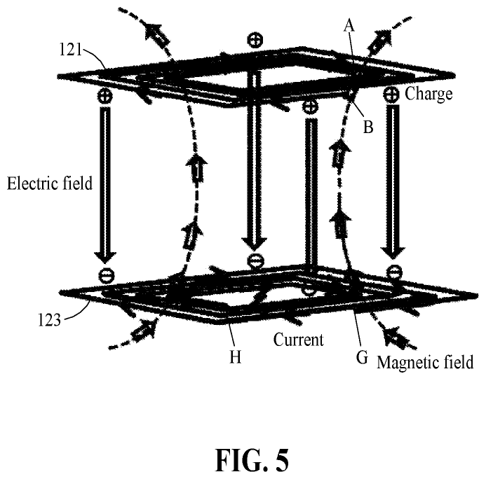

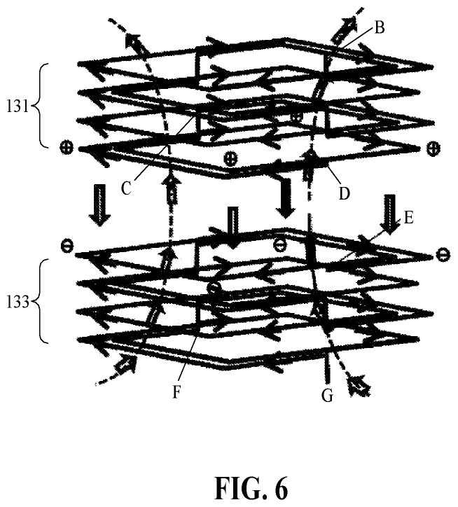

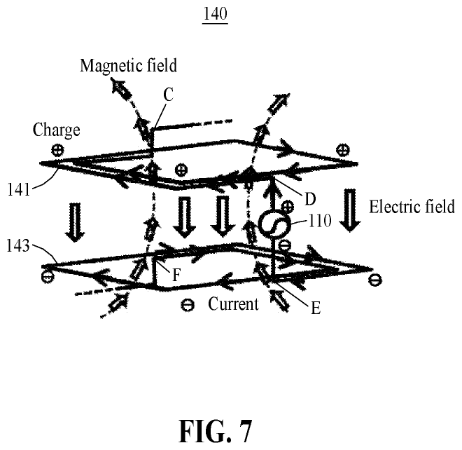

FIG. 5 is a diagram illustrating an upper spiral element 121 and a lower spiral element 123 of the Fraunhofer resonant coil 100 coupled with an electromagnetic field, according to various embodiments. FIG. 6 is a diagram illustrating an upper conical element 131 and a lower conical element 133 of the Fraunhofer resonant coil 100 coupled with an electromagnetic field, according to various embodiments. FIG. 7 is a diagram illustrating the feeding device 110 and a layer 141 of the upper conical element 131 and a layer 143 of the lower conical element 133 connected to the feeding device 110 of the Fraunhofer resonant coil 100 coupled with an electromagnetic field, according to various embodiments.

For example, when an uppermost layer 121 and a lowermost layer 123, a middle area, and a central area 140 shown in FIGS. 5, 6, and 7 are coupled with each other, the Fraunhofer resonant coil 100 as shown in FIG. 3 may be formed.

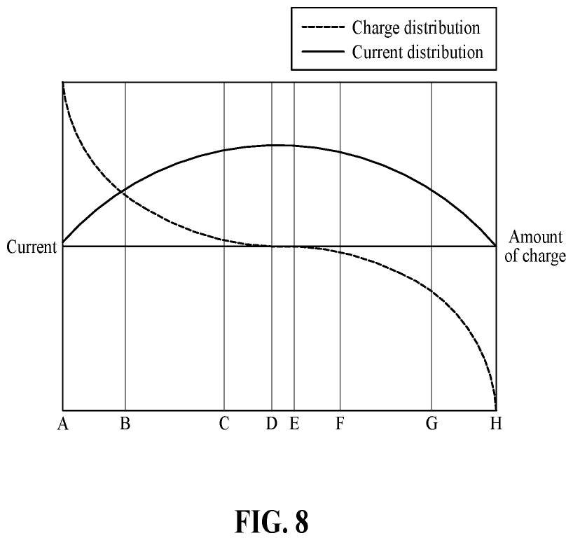

FIG. 8 is a diagram schematically illustrating current and charge distributions of the Fraunhofer resonant coil 100 coupled with an electromagnetic field, according to various embodiments. FIG. 8 schematically illustrates current and charge distributions of the Fraunhofer resonant coil 100 in which an upper structure and a lower structure are symmetrical with respect to the feeding device 110.

Referring to FIG. 5, the upper spiral element 121 and the lower spiral element 123 may be formed to be wound around the center of a resonant coil.

Referring to FIG. 6, the upper conical element 131 and the lower conical element 133 may be formed such that the one or more layers are formed in a circular shape.

Referring to FIG. 7, the upper conical element 131 and the lower conical element 133 may be formed such that the layers 141 and 143 connected to the feeding device 110 are wound around the center of a resonant coil.

In FIGS. 5 and 8, it may be seen that point A of the upper spiral element 121 is at the center of the Fraunhofer resonant coil 100 and has a high amount of charge. That is, the point A having the highest amount of charge in the upper spiral element 121 may be at the center of the Fraunhofer resonant coil 100.

In FIGS. 5 and 8, it may be seen that point B of the upper spiral element 121 is at the outermost portion of the Fraunhofer resonant coil 100 and has a large current. That is, the point B having the largest current in the upper spiral element 121 may be at the outermost portion of the Fraunhofer resonant coil 100.

In FIGS. 5 and 8, similar to the upper spiral element 121 described above, point H having the highest amount of charge in the lower spiral element 123 may be at the center of the Fraunhofer resonant coil 100 and the point G having the largest current may be at the outermost portion of the Fraunhofer resonant coil 100.

In FIG. 6, a layer formed between point C and point D of the upper conical element 131 may represent a portion of the upper conical element 131 shown in FIG. 7, and point E and point F of the lower conical element 133 may represent a portion of the lower conical element 133 shown in FIG. 7.

In FIG. 6, point B of the upper conical element 131 may be connected to the point B of the upper spiral element 121 shown in FIG. 5 and point G of the lower conical element 133 may be connected to point G of the lower spiral element 123 shown in FIG. 5.

In FIG. 7, the feeding device 110 may be connected between the point D of the upper conical element 131 and point E of the lower conical element 133.

In FIGS. 7 and 8, based on a position (e.g., around the horizontal axis of FIG. 8) of the feeding device 110, the point C of the upper conical element 131 and the point F of the lower conical element 133, which are points having a high amount of charge, may be positioned close to the center of the Fraunhofer resonant coil 100, and the point D of the upper conical element 131 and the point E of the lower conical element 133, which are points having a large current, may be positioned at the outmost portion of the Fraunhofer resonant coil 100.

Referring to FIGS. 5 to 7, directions of a magnetic field and an electric field generated in the Fraunhofer resonant coil 100 may be generated in the same direction at the center of a resonant coil.

For example, the gap of the Fraunhofer resonant coil 100 may be formed wider than a space of one or more layers of the upper conical element 131 and the lower conical element 133. The upper conical element 131 and the lower conical element 133 may be formed of an odd number of layers, and when the upper conical element 131 and the lower conical element 133 are an odd number of layers, the Fraunhofer resonant coil 100 may be easily manufactured.

Referring to FIGS. 5 to 8, the upper spiral element 121 and the lower spiral element 123 may be formed such that the points B and G, where the current is maximum, are at the outermost portion of the Fraunhofer resonant coil 100 and points A and H, where the charge is the maximum, are at the center of the Fraunhofer resonant coil 100.

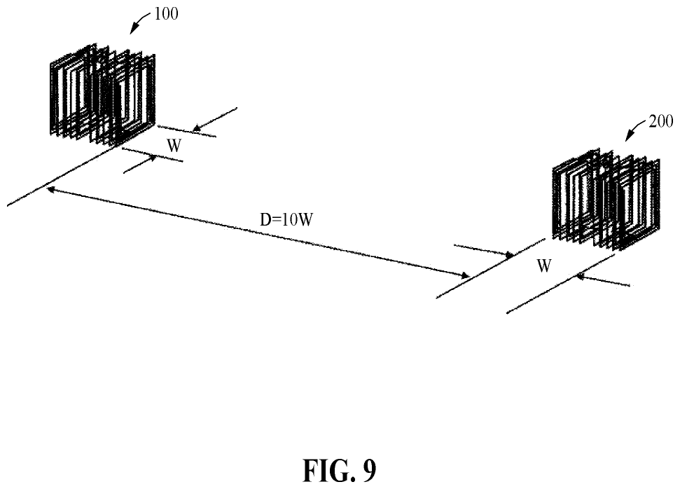

FIG. 9 is a diagram illustrating an operation of transmitting and receiving power using the Fraunhofer resonant coil 100 coupled with an electromagnetic field, according to various embodiments.

FIG. 9 is a diagram illustrating an example of Fraunhofer resonant coils 100 and 200 formed of 10 layers (the upper conical element 131 and the lower conical element 133 each having 4 layers). FIG. 9 is a diagram illustrating an example in which a transceiver element is made of copper at a separation distance 10 times the width (W=20 cm) of the Fraunhofer resonant coil 100 using the Fraunhofer resonant coil 100 coupled with an electromagnetic field. In FIG. 9, the Fraunhofer resonant coil 100 may transmit power and the Fraunhofer resonant coil 200 may receive power. In FIG. 9, when the transmission distance is converted based on the center of the Fraunhofer resonant coil 100 and the Fraunhofer resonant coil 200, 11 W may become the transmission distance.

For example, when power is transmitted using the Fraunhofer resonant coils 100 and 200, a power transmission device may include a power source, a frequency generator, a power amplifier, an inverter, an impedance matching circuit, a communication circuit, a processor. etc., other than the Fraunhofer resonant coil 100. In addition, a power reception device may include a rectifier circuit, a rechargeable battery, a communication circuit, etc., other than the Fraunhofer resonant coil 200.

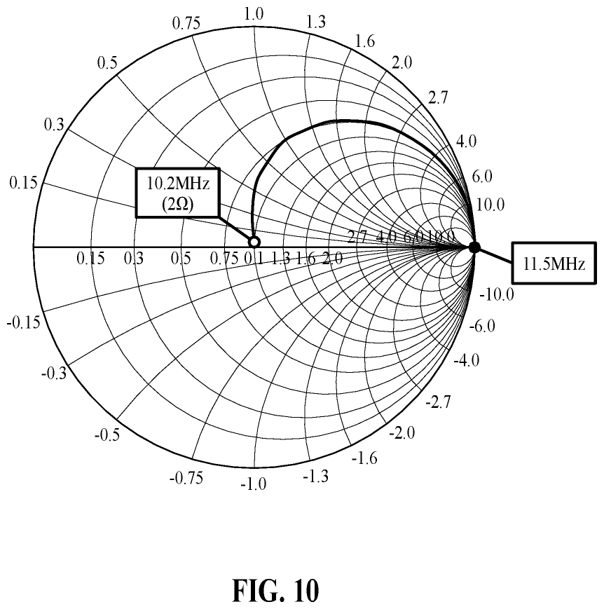

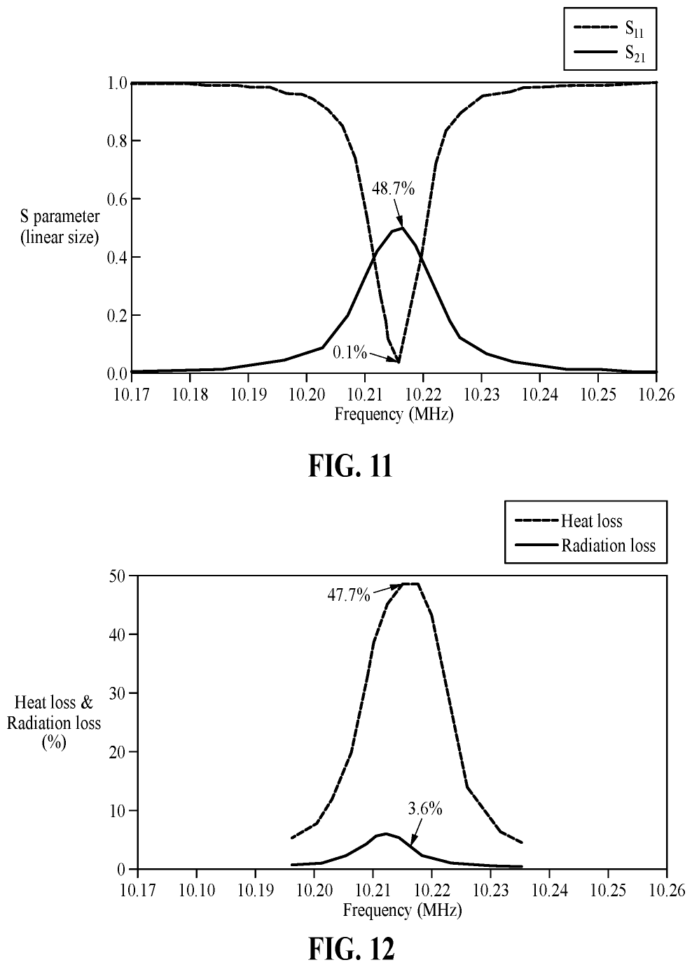

FIG. 10 is a diagram illustrating an impedance matching 2Ω smart chart of the Fraunhofer resonant coil 100 coupled with an electromagnetic field, according to various embodiments. FIG. 11 is a diagram illustrating an S parameter of the Fraunhofer resonant coil 100 coupled with an electromagnetic field, according to various embodiments. FIG. 12 is a diagram illustrating heat loss and radiation loss of the Fraunhofer resonant coil 100 coupled with an electromagnetic field, according to various embodiments.

FIGS. 10 to 12 are diagrams illustrating an impedance matching smart chart, an S parameter, and heat loss and radiation loss when power is transmitted using the Fraunhofer resonant coils 100 and 200 made of copper shown in FIG. 9.

FIG. 10 illustrates a case in which a resonant frequency is formed at about 10.2 megahertz (MHz). Referring to FIG. 10, when the transmission distance is 10 times the width W of the Fraunhofer resonant coil 100, the input/output matching impedance may greatly decrease. When the input/output impedance of the Fraunhofer resonant coils 100 and 200 is designed to be 2Ω, a system with less reflected power may be implemented, and when a common mode impedance that is commonly used is 50Ω or 75Ω, or to match a differential mode impedance with 100Ω or 150Ω to a system, an impedance matching circuit must be used between a resonant coil and other circuits. In this case, a loss may occur in the matching circuit.

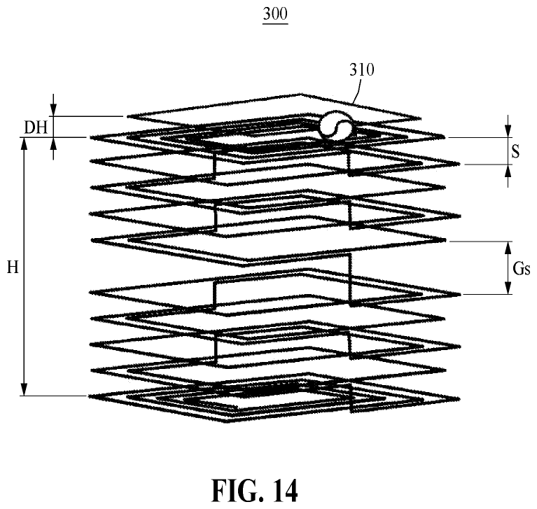

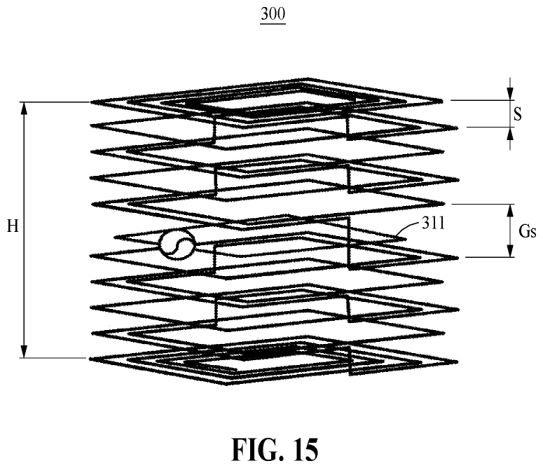

The loss due to the impedance matching circuit may be improved through a method of indirectly feeding power to a Fraunhofer resonant coil including a feeding loop shown in FIGS. 14 and 15 described below.

Referring to FIG. 11, it may be seen that the impedance matching is well made so that the return loss is maintained at about 0.1% at the resonant frequency of about 10.2 MHz and the power transmission efficiency is about 48.7%.

Referring to FIG. 12, it may be seen that the heat loss is about 47.7% and the radiation loss is about 3.6% in the power transmission using the Fraunhofer resonant coils 100 and 200. When the size of the Fraunhofer resonant coils 100 and 200 of FIG. 9 is manufactured large at the same proportion, the transmission distance is extended to 10 W, and the width W of a Fraunhofer resonant coil is extended to 30 cm, the power transmission efficiency may be improved to about 56.0%.

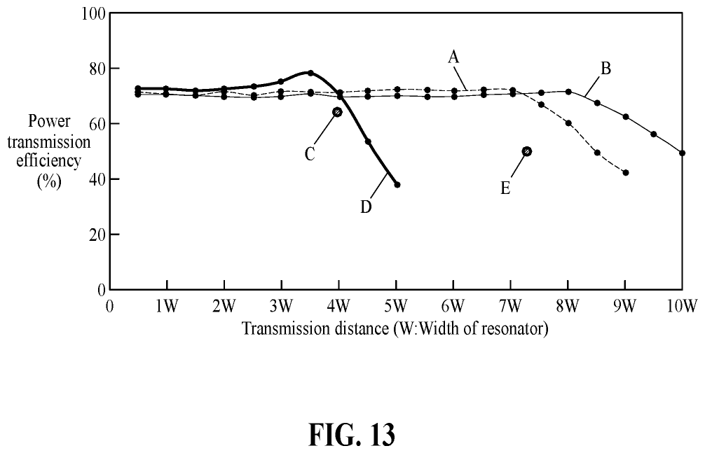

FIG. 13 is a diagram illustrating the power transmission efficiency of the Fraunhofer resonant coil 100 coupled with an electromagnetic field, according to various embodiments. FIG. 13 is a diagram illustrating that A represents a Fraunhofer resonant coil according to the related art, B represents the Fraunhofer resonant coil of FIG. 3, C represents a Fraunhofer resonant coil of an electrically small magnetic antenna (ESMA) model, D represents a single electromagnetic Fraunhofer resonant coil, and E represents the transmission efficiency of a four-arm EA-SHAs Fraunhofer resonant coil. The Fraunhofer resonant coils A, B, C, D, and E shown in FIG. 13 represent the power transmission efficiency when the Fraunhofer resonant coils A, B, C, D, and E are made of copper.

Referring to the power transmission efficiency of the Fraunhofer resonant coil B shown in FIG. 13, it may be seen that the transmission distance is greater than that of the other Fraunhofer resonant coils A, C, D, and E. Regarding the Fraunhofer resonant coils A, B, C, D, and E shown in FIG. 13, a width W of the Fraunhofer resonant coil B is 20 cm, while a width W of the Fraunhofer resonant coil A is 30 cm, and the diameter of the Fraunhofer resonant coil E is 62 cm, so it may be seen that the power transmission efficiency of the Fraunhofer resonant coil B is higher at a longer distance than that of the Fraunhofer resonant coils A and E having a larger size.

FIGS. 14 and 15 are diagrams illustrating a Fraunhofer resonant coil 300 coupled with an electromagnetic field including a feeding loop, according to various embodiments.

FIG. 14 illustrates an example of installing a feeding loop 310 on an outer portion of the Fraunhofer resonant coil 300 in the Fraunhofer resonant coil 300 coupled with an electromagnetic field and FIG. 15 illustrates an example (D=about 8 W and W=about 30 cm) of installing a feeding loop 311 using a gap Gs at the center of the inside of the Fraunhofer resonant coil 300.

As shown in FIG. 14, when the feeding loop 310 is installed at the outer portion of the Fraunhofer resonant coil 300, as the feeding loop 310 moves away from the Fraunhofer resonant coil 300 (as DH increases), the impedance of the Fraunhofer resonant coil 300 may be converted into the commercial impedance (50Ω to 150Ω). When the size of the feeding loop 310 is reduced, the impedance of the Fraunhofer resonant coil 300 may be converted into the commercial impedance (50Ω to 150Ω).

As shown in FIG. 15, when the feeding loop 311 is installed at the center (gap) of the inside of the Fraunhofer resonant coil 300 and power is supplied through the feeding loop 311, the Fraunhofer resonant coil 300 may be manufactured in a small size, compared to the Fraunhofer resonant coil 300 of FIG. 14.

In addition, to minimize wire twist of the Fraunhofer resonant coil 300, a support may be installed inside the Fraunhofer resonant coil 300 and the feeding loop 311 may be easily installed at the center of the inside of the Fraunhofer resonant coil 300 using the support.

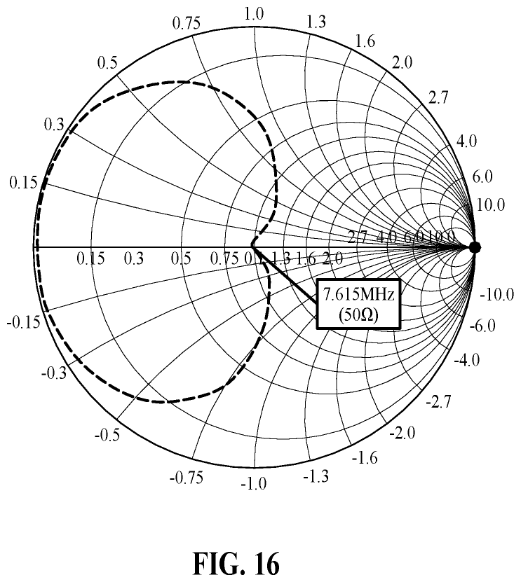

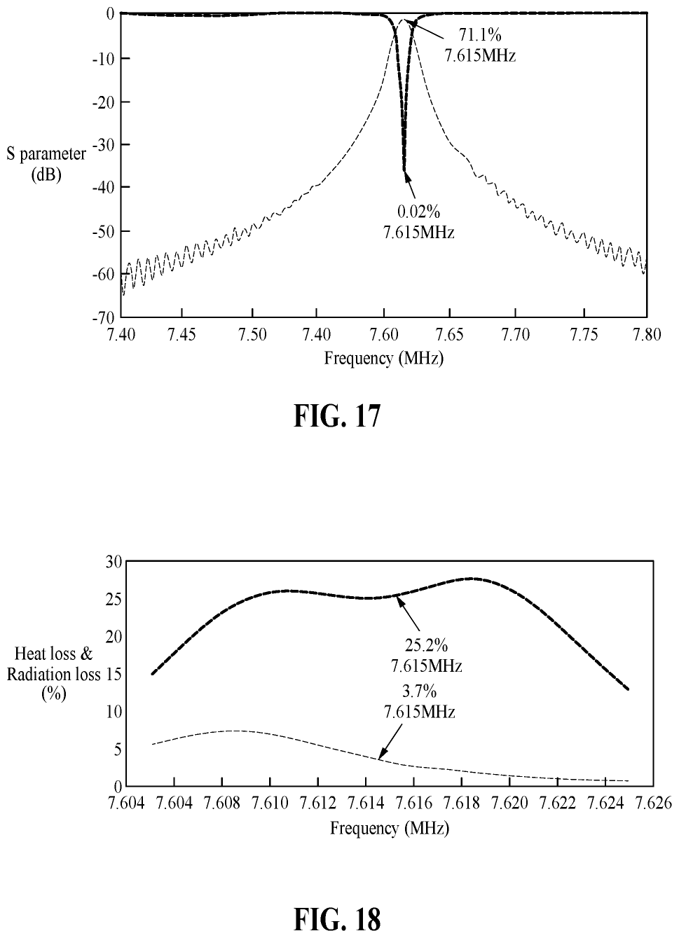

FIG. 16 is a diagram illustrating an impedance matching 2Ω smart chart of the Fraunhofer resonant coil 300 coupled with an electromagnetic field, according to various embodiments. FIG. 17 is a diagram illustrating an S parameter of the Fraunhofer resonant coil 300 coupled with an electromagnetic field, according to various embodiments. FIG. 18 is a diagram illustrating heat loss and radiation loss of the Fraunhofer resonant coil 300 coupled with an electromagnetic field, according to various embodiments.

FIGS. 16 to 18 are diagrams illustrating an impedance matching smart chart, an S parameter, and heat loss and radiation loss when power is transmitted using the Fraunhofer resonant coil 300 made of copper shown in FIG. 15 and including the feeding loop 311 at the center of a resonant coil.

FIG. 16 illustrates an evaluation result of a model manufactured with a width W (W=30 cm) in a regular hexahedral Fraunhofer resonant coil 300 structure of FIG. 15 with a distance D (D=8 W) between the transmission and reception. The resonant frequency is about 7.615 MHz and it may be seen that the impedance matching is made to about 50Ω.

FIG. 17 illustrates an evaluation result when the transmission/reception distance D is 8 W (i.e., D=8 W) and W is 30 cm (i.e., W=30 cm) in the structure of the Fraunhofer resonant coil 300 of FIG. 15. Referring to FIG. 17, it may be seen that the power transmission efficiency is 71.1% and the return loss is maintained at 0.02% at the resonant frequency of 7.615 MHz. As predicted by the smart chart evaluation of FIG. 16, it may be seen that the return loss greatly reduced because the impedance matching is well made.

FIG. 18 illustrates an evaluation result when the transmission/reception distance D is 8 W (i.e., D=8 W) and W is 30 cm (i.e., W=30 cm) in the structure of the Fraunhofer resonant coil 300 of FIG. 15.

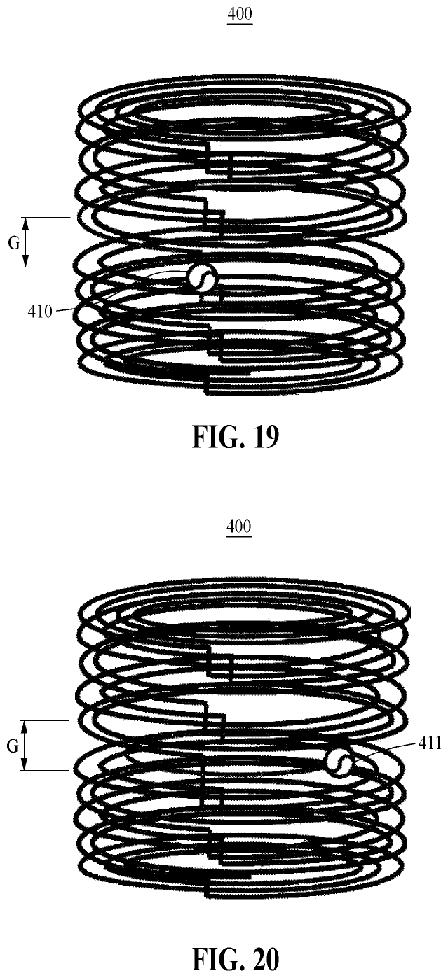

FIGS. 19 and 20 are diagrams illustrating a circular Fraunhofer resonant coil 400 coupled with an electromagnetic field, according to various embodiments.

As shown in FIGS. 19 and 20, when the Fraunhofer resonant coil 400 is formed in a circular shape, the Fraunhofer resonant coil 400 may be easily installed inside other devices (e.g., robots, automobiles, electric devices, electronic devices, etc.).

As shown in FIG. 19, a feeding device 410 may be installed at the central area of the Fraunhofer resonant coil 400, and as shown in FIG. 20, a feeding loop 411 may be installed at the central area of the Fraunhofer resonant coil 400.

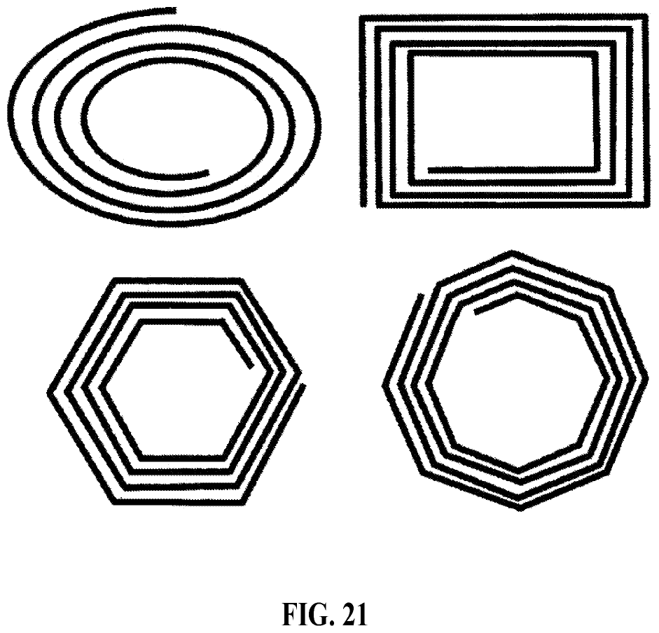

FIG. 21 is a diagram illustrating a shape of an upper spiral element and a lower spiral element of a Fraunhofer resonant coil coupled with an electromagnetic field, according to various embodiments.

Referring to FIG. 21, the upper spiral element and the lower spiral element may be formed in one of an elliptical shape, a rectangular shape, a hexagonal shape, and an octagonal shape. As shown in FIG. 21, the upper spiral element and the lower spiral element of a Fraunhofer resonant coil may be formed in one of an elliptical shape, a rectangular shape, a hexagonal shape, and an octagonal shape.

FIG. 22 is a diagram illustrating a shape of an upper conical element and a lower conical element of a Fraunhofer resonant coil coupled with an electromagnetic field, according to various embodiments.

Referring to FIG. 22, the upper conical element and the lower conical element may be formed such that a plurality of plies of a layer connected to a feeding device is formed in one of an elliptical shape, a rectangular shape, a hexagonal shape, and an octagonal shape. As shown in FIG. 22, the upper conical element and the lower conical element of the Fraunhofer resonant coil may be formed in an elliptical structure, a rectangular structure, a hexagonal structure, an octagonal structure, etc.

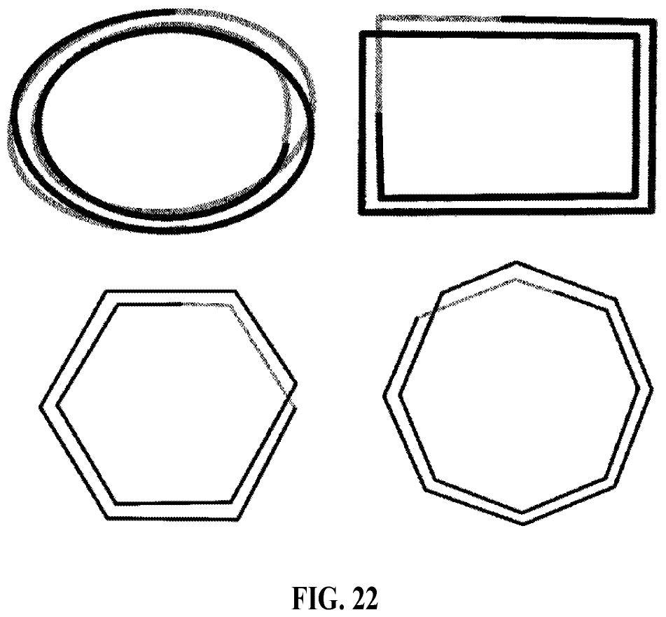

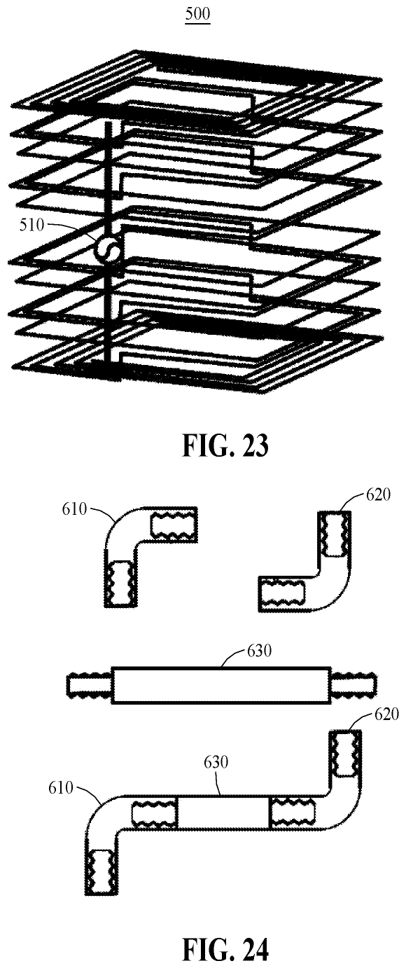

FIG. 23 is a diagram illustrating a Fraunhofer resonant coil 500 coupled with an electromagnetic field including a feeding dipole 510, according to various embodiments.

As in the example shown in FIG. 23, power may be supplied to the Fraunhofer resonant coil 500 using the feeding dipole 510.

The Fraunhofer resonant coil 500 using the feeding dipole 510 may have a characteristic similar to that of the Fraunhofer resonant coil 300 using the feeding loops 310 and 311. The Fraunhofer resonant coil 300 using the feeding loops 310 and 311 may feed power to the Fraunhofer resonant coil 300 using a magnetic field and the Fraunhofer resonant coil 500 using the feeding dipole 510 may feed power to the Fraunhofer resonant coil 500 using an electric field.

In the case of a Fraunhofer resonant coil coupled with an electromagnetic field, an electric field and a magnetic field are generated at the same time, as shown in FIGS. 14, 15, and 23, so the Fraunhofer resonant coil may receive power from the feeding loops 310 and 311 or the feeding dipole 510.

FIG. 24 is a diagram illustrating assembly components of a Fraunhofer resonant coil coupled with an electromagnetic field, according to various embodiments.

As shown in FIG. 24, a Fraunhofer resonant coil may be assembled by combining assembly components 610, 620, and 630. For example, as shown in FIG. 24, a connector for forming layers of the Fraunhofer resonant coil may be formed by combining the assembly component 610, the assembly component 620, and the assembly component 630. Layers of the Fraunhofer resonant coil may be connected to each other using the connector.

In addition, the assembly component 610 and/or the assembly component 620 may form a corner of a lower conical element, an upper conical element, a lower spiral element, and an upper spiral element, and the assembly component 630 may form a straight line of the lower conical element, the upper conical element, the lower spiral element, and the upper spiral element.

For example, the size of a gap of the Fraunhofer resonant coil may be determined based on a resonant frequency. For example, as the length of the central area of the Fraunhofer resonant coil increases, the size of capacitance components generated on an upper side and a lower side of the Fraunhofer resonant coil decreases, so the resonant frequency may increase.

For example, as the length of the central area of the Fraunhofer resonant coil decreases, the size of capacitance components generated on the upper side and the lower side of the Fraunhofer resonant coil increases, so the resonant frequency may decrease.

The size of the gap of the Fraunhofer resonant coil may be adjusted according to the length of the assembly component 630 shown in FIG. 24. For example, when the length of the assembly component 630 for forming the central area of the Fraunhofer resonant coil increases, the gap of the Fraunhofer resonant coil may increase and the resonant frequency may increase.

When the Fraunhofer resonant coil is manufactured using the assembly components 610, 620, and 630, the size of the gap at the central area of the Fraunhofer resonant coil may be adjusted and the resonant frequency of the Fraunhofer resonant coil may be tuned according to the size of the gap.

In FIG. 24, the assembly components 610, 620, and 630 may represent the rectangular elements 610 and 620 capable of assembling and the linear element 630 capable of assembling. The coupled assembly components 610, 620 and 630 may represent connection elements connecting layers and capable of assembling.

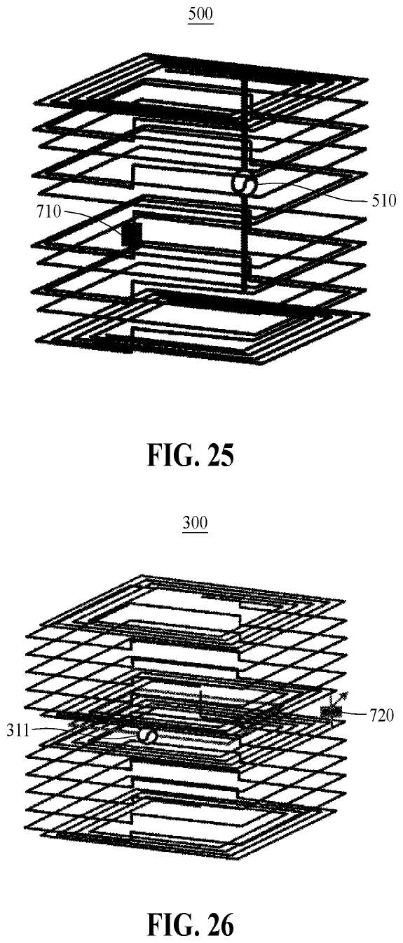

FIG. 25 is a diagram illustrating a Fraunhofer resonant coil coupled with an electromagnetic field including a fixed reactance (LC) element, according to various embodiments. FIG. 26 is a diagram illustrating a Fraunhofer resonant coil coupled with an electromagnetic field including a variable LC element, according to various embodiments.

FIG. 25 illustrates the Fraunhofer resonant coil 500 including the feeding dipole 510 and a fixed LC element 710 and FIG. 26 illustrates the Fraunhofer resonant coil 300 including the feeding loop 311 and a variable LC element 720.

As shown in FIGS. 25 and 26, a resonant frequency of a Fraunhofer resonant coil may be determined according to the fixed LC element 710 and/or the variable LC element 720. For example, when there is a limitation in controlling the resonant frequency using the length or the size of a gap of a Fraunhofer resonant coil, the resonant frequency of the Fraunhofer resonant coil may be controlled by applying the fixed LC element 710 and/or the variable LC element 720 to a resonant coil.

For example, in the wireless power transmission system shown in FIG. 9, a wireless power transmission device or a wireless power reception device may measure received power and tune the resonant frequency by controlling the fixed LC element 710 and/or the variable LC element 720.

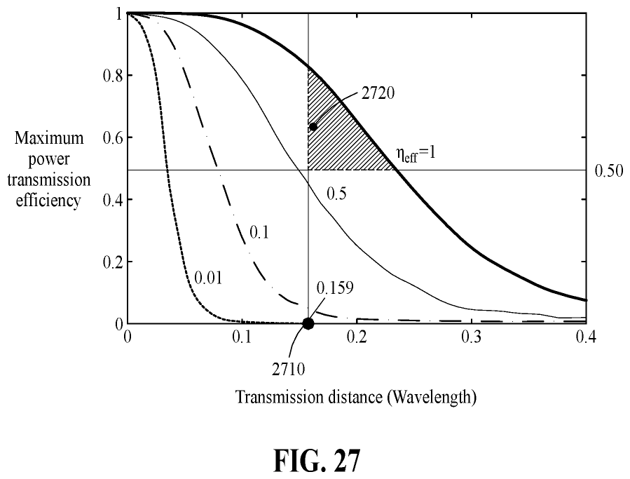

FIG. 27 is a diagram illustrating the power transmission efficiency measured in a Fraunhofer region when the Fraunhofer resonant coil 300 of FIG. 15 is designed as a perfect conductor, according to various embodiments. The Fraunhofer region may be divided based on a point 2710 at which the transmission distance is 0.159λ.

As shown in FIG. 27, when the Fraunhofer resonant coil 300 is designed as a perfect conductor structure, it may be seen that power transmission efficiency 2720 of the Fraunhofer resonant coil 300 is about 64% at 20 times the transmission distance (D=0.162λ). That is, according to various embodiments, the Fraunhofer resonant coils 100, 300, 400, and 500 may have high power transmission efficiency even when the transmission distance is in the Fraunhofer region.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The method according to embodiments may be written in a computer-executable program and may be implemented as various recording media such as magnetic storage media, optical reading media, or digital storage media.

Various techniques described herein may be implemented in digital electronic circuitry, computer hardware, firmware, software, or combinations thereof. The implementations may be achieved as a computer program product, i.e., a computer program tangibly embodied in an information carrier, e.g., in a machine-readable storage device (for example, a computer-readable medium) or in a propagated signal, for processing by, or to control an operation of, a data processing apparatus, e.g., a programmable processor, a computer, or multiple computers. A computer program, such as the computer program(s) described above, may be written in any form of a programming language, including compiled or interpreted languages, and may be deployed in any form, including as a stand-alone program or as a module, a component, a subroutine, or other units suitable for use in a computing environment. A computer program may be deployed to be processed on one computer or multiple computers at one site or distributed across multiple sites and interconnected by a communication network.

Processors suitable for processing of a computer program include, by way of example, both general and special purpose microprocessors, and any one or more processors of any kind of digital computer. Generally, a processor will receive instructions and data from a read-only memory or a random-access memory, or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tape, optical media such as compact disk read only memory (CD-ROM) or digital video disks (DVDs), magneto-optical media such as floptical disks, read-only memory (ROM), random-access memory (RAM), flash memory, erasable programmable ROM (EPROM), or electrically erasable programmable ROM (EEPROM). The processor and the memory may be supplemented by, or incorporated in special purpose logic circuitry.

In addition, non-transitory computer-readable media may be any available media that may be accessed by a computer and may include both computer storage media and transmission media.

Although the present specification includes details of a plurality of specific embodiments, the details should not be construed as limiting any invention or a scope that can be claimed, but rather should be construed as being descriptions of features that may be peculiar to specific embodiments of specific inventions. Specific features described in the present specification in the context of individual embodiments may be combined and implemented in a single embodiment. On the contrary, various features described in the context of a single embodiment may be implemented in a plurality of embodiments individually or in any appropriate sub-combination. Furthermore, although features may operate in a specific combination and may be initially depicted as being claimed, one or more features of a claimed combination may be excluded from the combination in some cases, and the claimed combination may be changed into a sub-combination or a modification of the sub-combination.

Likewise, although operations are depicted in a specific order in the drawings, it should not be understood that the operations must be performed in the depicted specific order or sequential order or all the shown operations must be performed in order to obtain a preferred result. In specific cases, multitasking and parallel processing may be advantageous. In addition, it should not be understood that the separation of various device components of the aforementioned embodiments is required for all the embodiments, and it should be understood that the aforementioned program components and apparatuses may be integrated into a single software product or packaged into multiple software products.

The embodiments disclosed in the present specification and the drawings are intended merely to present specific examples in order to aid in understanding of the present disclosure, but are not intended to limit the scope of the present disclosure. It will be apparent to those skilled in the art that various modifications based on the technical spirit of the present disclosure, as well as the disclosed embodiments, can be made.

What is claimed is:

1. A Fraunhofer resonant coil comprising:
an upper spiral element and a lower spiral element;
an upper conical element connected to the upper spiral element and comprising one or more layers formed of a plurality of plies;
a lower conical element connected to the lower spiral element and comprising one or more layers formed of a plurality of plies; and
a feeding device connected to a gap between the upper conical element and the lower conical element and configured to supply power.

2. The Fraunhofer resonant coil of claim 1, wherein the upper spiral element and the lower spiral element are formed to be wound around a center of a resonant coil.

3. The Fraunhofer resonant coil of claim 1, wherein the upper conical element and the lower conical element are formed such that a layer connected to the feeding device is wound around a center of a resonant coil.

4. The Fraunhofer resonant coil of claim 1, wherein the one or more layers of the upper conical element and the lower conical element are an odd number of layers.

5. The Fraunhofer resonant coil of claim 1, wherein the upper conical element and the lower conical element are formed such that the one or more layers are formed in a circular shape.

6. The Fraunhofer resonant coil of claim 1, wherein the upper spiral element and the lower spiral element are formed in one of an elliptical shape, a rectangular shape, a hexagonal shape, and an octagonal shape.

7. The Fraunhofer resonant coil of claim 1, wherein the upper conical element and the lower conical element are formed such that a plurality of plies of a layer connected to the feeding device is formed in one of an elliptical shape, a rectangular shape, a hexagonal shape, and an octagonal shape.

8. The Fraunhofer resonant coil of claim 1, wherein the gap is formed greater than a space between a plurality of layers of the upper conical element and a plurality of layers of the lower conical element.

9. The Fraunhofer resonant coil of claim 1, wherein a size of the gap is determined based on a resonant frequency of the Fraunhofer resonant coil.

10. The Fraunhofer resonant coil of claim 1, further comprising:
a reactance (LC) element to adjust a resonant frequency of the Fraunhofer resonant coil.

11. The Fraunhofer resonant coil of claim 1, wherein
the upper spiral element and the lower spiral element are formed using a linear element and a rectangular element capable of assembling, and
the upper conical element and the lower conical element are formed using the linear element, the rectangular element, and a connection element connecting the one or more layers and capable of assembling.

12. The Fraunhofer resonant coil of claim 1, wherein the upper spiral element and the lower spiral element are formed such that a point where a current is maximum is at an outermost portion of the Fraunhofer resonant coil and a point where a charge is maximum is at a center of the Fraunhofer resonant coil.

13. A Fraunhofer resonant coil comprising:
an upper spiral element and a lower spiral element;
an upper conical element connected to the upper spiral element and comprising a plurality of plies and one or more layers;
a lower conical element connected to the lower spiral element and the upper conical element and comprising a plurality of plies and one or more layers; and
a feeding loop configured to supply power to at least one of the upper spiral element, the lower spiral element, the upper conical element, and the lower conical element by generating a magnetic field.

14. The Fraunhofer resonant coil of claim 13, wherein the feeding loop is positioned on one side of the upper spiral element or one side of the lower spiral element.

15. The Fraunhofer resonant coil of claim 13, wherein the feeding loop is at a gap between the upper conical element and the lower conical element.

16. The Fraunhofer resonant coil of claim 13, wherein the upper spiral element and the lower spiral element are formed to be wound around a center of a resonant coil.

17. The Fraunhofer resonant coil of claim 13, wherein the upper conical element and the lower conical element are formed such that a layer connected to the feeding device is wound around a center of a resonant coil.

18. A Fraunhofer resonant coil comprising:
an upper spiral element and a lower spiral element;
an upper conical element connected to the upper spiral element and comprising a plurality of plies and one or more layers;
a lower conical element connected to the lower spiral element and the upper conical element and comprising a plurality of plies and one or more layers; and
a feeding dipole configured to supply power to at least one of the upper spiral element, the lower spiral element, the upper conical element, and the lower conical element by generating an electric field.

19. The Fraunhofer resonant coil of claim 18, wherein the upper spiral element and the lower spiral element are formed to be wound around a center of a resonant coil.

20. The Fraunhofer resonant coil of claim 18, wherein the upper conical element and the lower conical element are formed such that a layer connected to the feeding device is wound around a center of a resonant coil.
